(19) United States
(12) Patent Application Publication
(10) Pub. No.: US 2013/0204743 A1
(43) Pub. Date: Aug. 8, 2013

(54) MOBILE SHOPPING TOOLS UTILIZING COLOR-BASED IDENTIFICATION, SEARCHING AND MATCHING ENHANCEMENT OF SUPPLY CHAIN AND INVENTORY MANAGEMENT SYSTEMS

(71) Applicant: ZENCOLOR CORPORATION, Coral Gables, FL (US)

(72) Inventors: Dann GERSHON, Coral GAbles, FL (US); David ROBINSON, Jersey City, NJ (US); Jonathan WILDER, Miami, FL (US)

(73) Assignee: ZENCOLOR CORPORATION, Coral Gables, FL (US)

(21) Appl. No.: 13/762,281

(22) Filed: Feb. 7, 2013

Related U.S. Application Data
(60) Provisional application No. 61/595,887, filed on Feb. 7, 2012.
(60) Provisional application No. 61/656,206, filed on Jun. 6, 2012.
(60) Provisional application No. 61/679,973, filed on Aug. 6, 2012.

(51) Int. Cl. G06Q 30/06

(52) U.S. Cl. CPC G06Q 30/0639
USPC 705/26.9

(57) ABSTRACT

A mobile-enabled system, methods and interfaces for merchants and consumers to identify, search for and match products based on color. The mobile platform provides a number of additional features to enhance shopping experiences, including features which display and/or direct a user to products within a store, by color or other user preferences. These features are enabled by accessing and downloading a combination of store schematics, planogram data, and inventory management systems data.

### RELATED APPLICATIONS

The present invention claims priority to U.S. Provisional Patent Application No. 61/595,887 filed on Feb. 7, 2012, U.S. Provisional Patent Application No. 61/656,206 filed on Jun. 6, 2012, and U.S. Provisional Patent Application No. 61/679,973 filed on Aug. 6, 2012, all incorporated herein by reference. This application further incorporates by reference U.S. application Ser. No. 13/762,160 and PCT Application No. PCT/US2013/025135, filed herewith and entitled Color-Based Identification, Searching and Matching Enhancement of Supply Chain and Inventory Management Systems.

### FIELD OF THE INVENTION

The present invention is directed to mobile shopping tools which deliver improved shopping experiences to a consumer. More particularly, the invention involves the dynamic application of information from merchant management systems to provide users with tools and benefits that enhance a consumer shopping experience. Even more particularly, these tools include local delivery of schematics and planograms which are used by a mobile device to guide users in a store to products of interest, by color and/or other product attributes.

### BACKGROUND OF THE INVENTION

At times, a user will want to search for a product by color even though it is an attribute that cannot be described adequately using words. For example, other than using rudimentary color names, such as “red” and “blue,” searching for products of a particular shade using color as a parameter is extremely difficult, even when the color is relatively popular and intuitively should be easy to locate. For example, there are numerous colors which would fit the simple “red” or “blue” description, and searching using the textual word “red” is not likely to bring up the specific red or the specific product of interest. Also, searches based on a particular type of color by name, such as “rose red” or “ocean blue” are unlikely to turn up the color of interest, as there may be a number of different colors, each with a different name or with multiple names varying by the naming convention used. Similarly, searching for a pattern made of colors, such as “blue and red stripes” is unlikely to turn up the desired pattern of particular colors.

Many of the drawbacks involving color-based searching stem from the nature of internet searching, which has historically been text-based, thus requiring a user to enter text into a search engine to describe the information sought. With regard to color, textual color names are typically tagged or embedded beneath an image of a product or associated webpage as metadata, making it virtually impossible to obtain reliable and complete search results when specific color shades are sought. More specifically, because many search systems that implement searching based on a color (or a pattern) are operable only as text searching, a system may allow a user to select a color by name or even “click” on the color (in the form of a color swatch) and then search for the selected color. However, in these instances, the system typically converts the inputted search parameter to a text-string associated with or representing a particular color. For example, a search system may search based on clicking red swatch on a webpage but converts the click to a search for “red” as text, but not as an actual color. In such a system, the name of the color “red” is “tagged” to an image by way of a text string and the search is based by matching the input “red” to the text string “red” on the tag, and not to the color. From a consumer's perspective, such a system is insufficient to reliably capture all relevant products of a particular shade of red that are being sought. From a merchant perspective, such a system does not allow for dynamic analysis or codification of color which is a crucial but missing data set in understanding consumer preferences.

Another problem with contemporary color searching is a lack of universal color codification and unifying color naming conventions. For example, even when a search using a specific color such as “cherry red” yields some relevant results when utilizing a search engine or a search field on a particular merchant's website (i.e., where the merchant utilizes the term “cherry red” as a tag to identify some of its products), such searches do not yield all of the relevant results for the particular type of red being searched. This is the case even when there are available products sold by other merchants that have the identical color or a close equivalent color but which use a term other than “cherry red” to identify that color.

Even color systems that offer naming conventions suffer from underlying drawbacks in their inconsistent application by merchant users and their vendors. For example, a wholesale buyer for a retailer may decide to order a line of products from a vendor in a color that is identified as “cobalt blue.” A second wholesale buyer at the same retailer may order another line of products from a second vendor in a color that the second buyer also identifies “cobalt blue,” having the intention that the colors be precisely the same so that a purchaser of product from the first line will be more inclined to purchase the second line of product as a matching set. Indeed, the variation in color between two products that purportedly have the ‘same color’ can be remarkable when the products are placed side by side. The lack of consistency among vendors and suppliers, even when the same color names are utilized, is often not appreciated until after the products arrive, at which time it is too late to ameliorate the situation.

The drawbacks presented above with respect to color are compounded in the context of mobile shopping where restrictions in bandwidth frustrate the download of color imagery to mobile devices. Since mobile bandwidth is often restricted in one form or another, the downloading of color images typically results in long loading times, deterring users in the first instance from attempting to search for products on the web, particularly when they are in color. This type of situation has resulted in a need to provide more ‘color-targeted’ search results in response to a user query, so that when users actually take the time to wait for color images to download, the results correspond more accurately to items the user wishes to find.

Furthermore, current mobile shopping systems lack the ability to direct a user to known and preferred products of interest within a store. In that regard, while conventional mobile shopping applications are capable of directing users to a store, these systems lack the ability to direct a user through and within a store to preferred products and to products having designated colors.

### BRIEF DESCRIPTION OF THE PRESENT INVENTION

It is a primary objective of the present invention to provide a mobile-enabled system, methods and interfaces for merchants and consumers to identify, search for and match products based on color.

It is another objective of the present invention to provide a universal convention for color-based identification, searching and matching across multiple proprietary platforms for consumers and merchants to conduct more efficient searches and provide more relevant and up-to-date product results.

A further object of the present invention is to provide a system, method and interfaces to provide guidance to a user and enable a user to locate products within a store, by color or other physical attribute, by accessing a combination of store schematics, layout or planogram data, inventory management systems and a database with data corresponding to various user interests.

Further objectives of the invention will be apparent from the disclosure which follows. Generally, the present invention is directed to a mobile-enabled system enhancement for identifying, searching for and matching products based on color and/or pattern across multiple proprietary supply chain management systems (SCM) and/or inventory management systems (IMS) that functions together, and often interchangeably, with the same system hardware and software implemented and available in the non-mobile version of the present invention disclosed herein. Like its desktop complement, the mobile version enhancement of the present invention is also directed to recognition and matching of products by color and/or pattern and a number of other more conventional attributes. The present invention also lends itself to data aggregation, analysis and making purchase recommendations to consumers that are based, at least in part, on color and/or pattern, potentially in combination with other available information to provide users with more of what they actually want.

The present invention may stand on its own or serve as an enhancement of or upgrade to IMS and/or SCM systems directed to facilitating a wide range of functions, including search, product selection, purchase, marketing, advertising, product planning and sales. An overarching goal of the present invention is the application of operations research principles to selected problems in retailing by organizing and identifying products according to color and/or pattern and by using those attributes as primary indicators, where retailing extends from product development and manufacturing through customer service.

The system includes one or more servers operated by machine-readable software instructions present on non-transitory computer readable storage media to perform a variety of functions associated with product identification, searching and matching utilizing color as a principle attribute. While some additional hardware and/or software constructs are required to implement the mobile features of the present invention, those of ordinary skill in the computer and software arts will appreciate how to implement these features based on the disclosure herein.

The system of the present invention is designed and intended to perform the following tasks:

1. Process and integrate data from merchant IMS and SCM system(s) via formatted data feeds to create a database of products with corresponding color information (i.e., digitally defined color identifier);

2. Gather available supplementary data from merchant IMS and SCM system(s) via formatted data feeds which are used to enhance the user shopping experience and the merchant commercial experience from the initiation of production through final sale;

3. Provide interfaces for users to query product databases with real-time merchant IMS and SCM system(s) information, using digitally defined color identifiers, and to purchase products from multiple merchants based on color and other customizable parameters;

4. Dynamically analyze codified color-based preferences, trends and system-wide activities to make targeted and micro-targeted product recommendations to users with color as a primary product attribute; and

5. Provide a mobile shopping platform, which in addition to providing many of the same tools that are available in the non-mobile platform, also enables a user to locate products within a store by accessing and displaying store schematics, planogram data and available product data, as well as a database with data representing consumer product interest or preferences.

Generally, the present invention provides a system, methods and a set of interfaces that provide users and merchants with a number of previously unavailable opportunities and tools in the context of color identification, selection and matching. One significant feature of the present invention is a color matching system that is more effective for both users and merchants than current methods used to search and match colors. When utilizing this feature, users are supplied with increasingly relevant search results for a number of merchant products that correlate more closely (or exactly) to the colors for which a user is searching.

Another significant feature set of the present invention lends itself to enhancing the mobile shopping experiences of and interactions between a user and a merchant. In that regard, the present invention includes a mobile-enabled application and interface that are integrated with the rest of the system. The mobile application enables a user to identify the precise location of a product within in a store upon specifying or querying preferred product attributes, particularly, color. In addition to directing a user to and/or displaying the location of products that a user already knows it wants to purchase, the system may also direct a user and/or display the location of different products of potential interest that each have a color which has been selected by a user to be a preferred or bookmarked color.

With respect to the hardware of the system, CPU-based servers are arranged to communicate with one another and with one or more data warehouses, preferably residing therein, which are used to store user data, merchant data, product data, and color data. In a preferred embodiment, servers receive formatted data feeds from IMS and SCM systems which populate the data warehouse once the data is normalized by machine processes. The servers and software gather, parse and filter the data warehouse data according to encoded instructions to allow a user to search for and purchase products from merchants.

### BRIEF DESCRIPTION OF THE FIGURES

The above-described and other advantages and features of the present disclosure will be appreciated and understood by those skilled in the art from the following detailed description and drawings of which:

FIG. 1 illustrates a basic system configuration fashioned in accordance with the present invention;

FIG. 2 is a flow diagram depicting the consumption and integration of proprietary merchant IMS and SCM systems data carried out by machine processes that perform the functions of data normalization, dynamic analysis, conversion and storage, and data syncing;

FIGS. 3A and 3B together comprise a system diagram depicting interaction among various system segments and functions carried out in accordance with the present invention, including data consumption, data search and data analytics;

FIG. 4 shows an example display of an interface for a mobile application of the present invention, as would appear on a mobile computing device.

FIG. 5 shows the display of the product locator function of the present invention, as would appear on a mobile computing device.

### DETAILED DESCRIPTION OF THE INVENTION

The present invention is directed to a series of mobile shopping tools accessible via a graphical user interface and corresponding application resident on a mobile computing device, such as a smart phone or tablet computer. The mobile shopping tools disclosed herein take advantage of and build upon the infrastructure implemented in connection with what may be referred to the ‘desktop embodiment’ even though many of its features may also be carried out utilizing a mobile device. Accordingly, there is significant overlap between the features enabled in the mobile platform and those available in a more restricted environment.

The basic system upon which the mobile shopping platform is built is described below as a framework and to provide context for the mobile platform and its features. By leveraging the existing framework, the mobile shopping tools provide users with a unique shopping experience that help users find specific items for which they have entered the store in the first place and/or suggest products based on color preferences and/or other physical attributes.

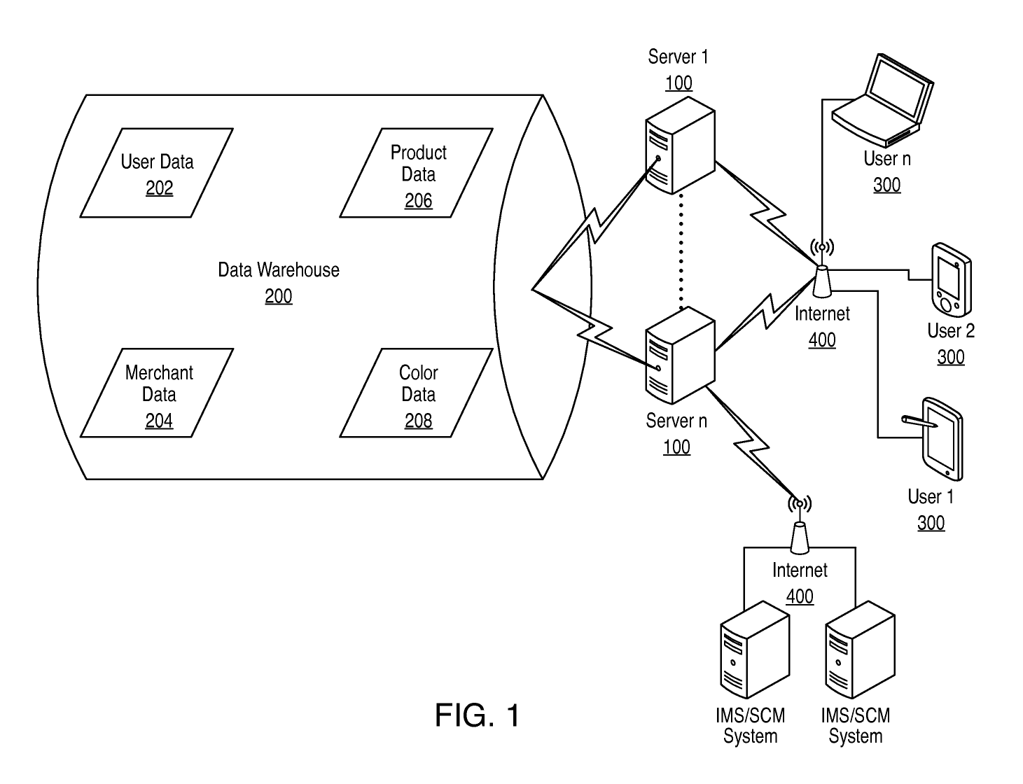

With reference to FIG. 1 there is shown a basic system configuration comprising a processor-based machine, such as computer(s) or server(s) 100, with hard disk or memory drives running software comprising machine readable program instructions. Server 100 serves as and/or provides access to data warehouse 200, which comprises data stores with information related to users 202, data stores with information related to merchants 204, data stores with information related to products 206, and data stores with information related to color 208. All data are maintained in data warehouse 200 or other conventional database system having read and write accessibility using a database management system. Although described herein for illustrative purposes as being separate data stores, in at least some alternative embodiments, the data stores may be combined in various combinations.

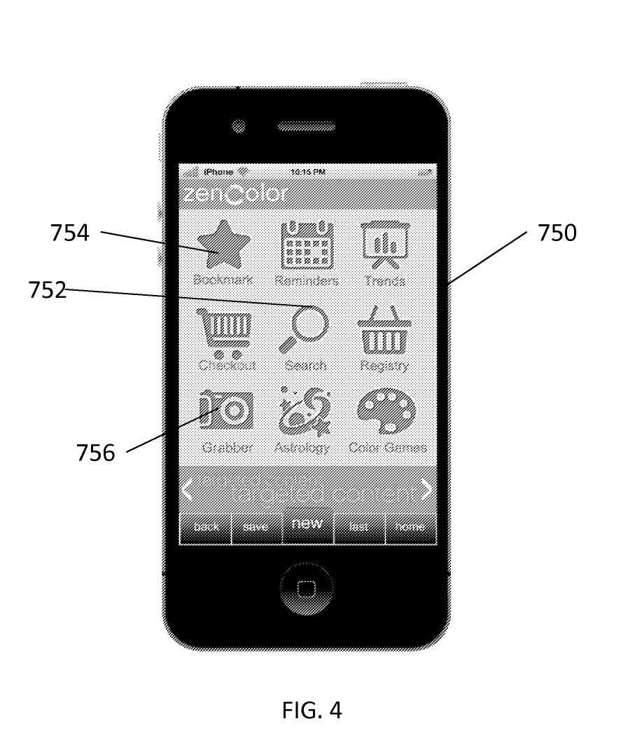

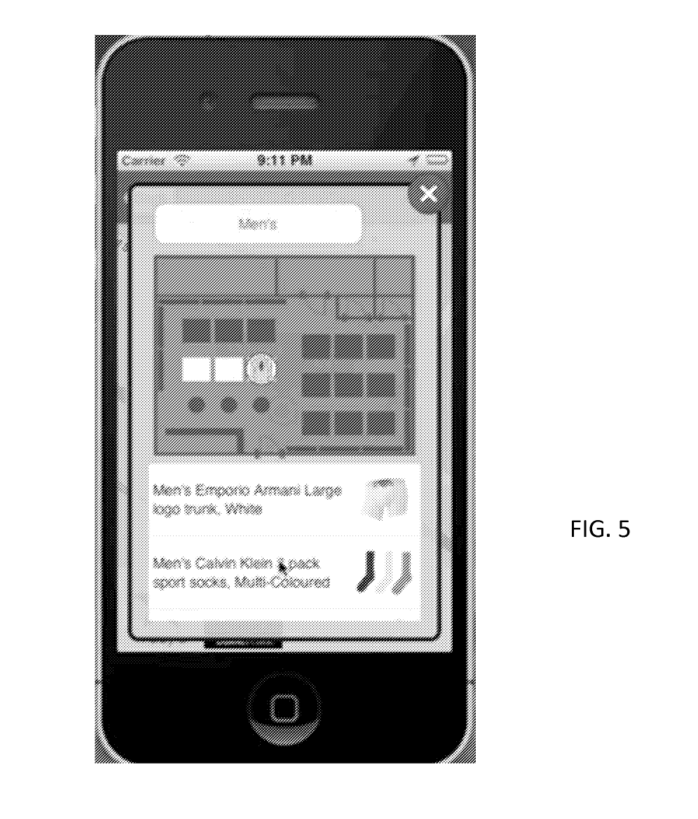

Information contained in data warehouse 200 is accessible by both consumer and merchant users operating devices 300 over the Internet 400. Devices 300 comprise processor-based machine(s), such as laptops, PCs, tablets and/or other handheld devices to and from which server 100 communicates. Devices 300 are connected to server 100 utilizing customizable interfaces described herein. Custom interfaces may be in the form of a graphical user interface, such as the mobile platform interface shown in FIG. 4 and FIG. 5, an application to form a client-server arrangement and/or other well-known interface conventions known in the art. Depending on the nature of the user and its access to various forms of information, different interfaces are made available. To support various options, the system of the present invention may include at least one application programming interface (API) so that certain types of users could enhance their interfaces, and different ones may be available for users and merchants.

Each data set introduced in the data warehouse 200 represents interrelated data sets that communicate with and rely on other data sets for complete information (but do not necessarily represent discrete data sets). These data sets may be accessed using a variety of database management systems (DBMS), including but not limited to relational database management systems (RDBMS) and “post-relational” database management systems (e.g., not only Structured Query Language (“NOSQL”) database management systems). In this manner, the data sets illustrated in FIG. 1, namely, user data 202, merchant data 204, product data 206 and color data 208, are meant to be purely illustrative and are not intended to necessarily depict a physical housing of data. Furthermore, by using a DBMS such as RDBMS or a “post-relational” DBMS, the data may be available to a merchant in a variety of manners, such as based on a specific demographic profile or a specific color or color grouping.

In a preferred embodiment of the present invention, user data 202 includes data specific to individual users which users may wish to make available, such as:

1. Personal information, including but not limited to, username, name, address (and more generalized geographic information), telephone data, birth date information, astrological information, keywords with which the user associates, colors with which the user associates specific keywords, etc.

2. Demographic information, including but not limited to, age, gender, education history, income, marital status, occupation and religion.

3. Color preference and bookmark data;

4. Product history information, including but not limited to, browsing history, product ratings (e.g., like and hide), purchase history, favorite stores, favorite brands; and

5. Social information including specifics for user-to-user or user-to-merchant associations including, but not limited to, friends, family, colleague, romance, and acquaintance associations.

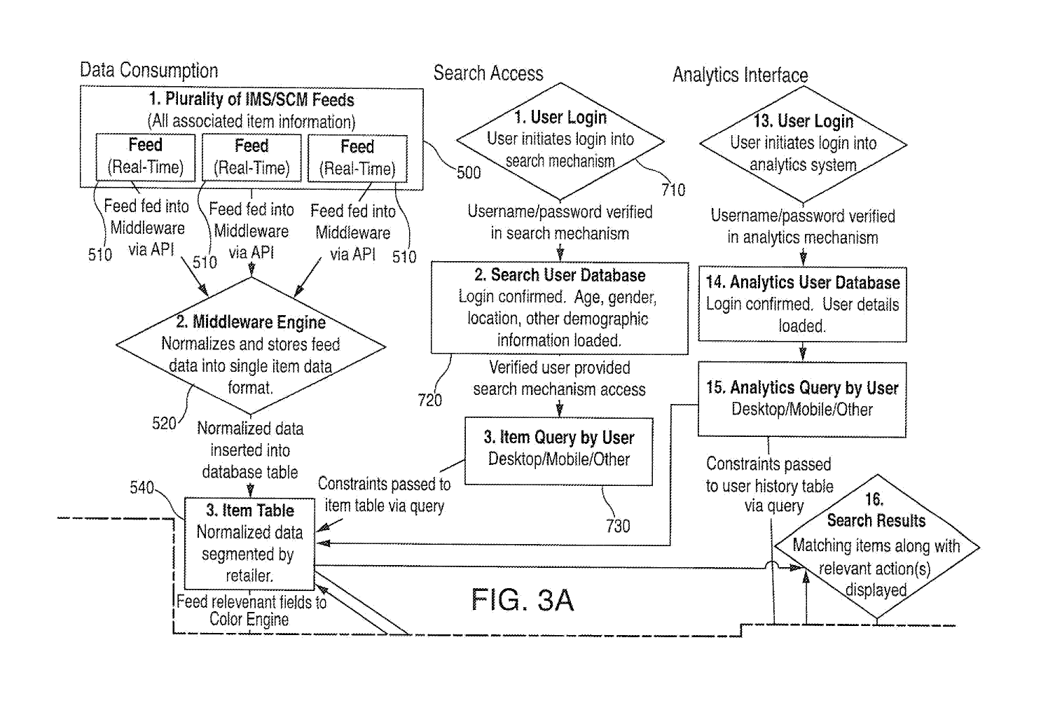

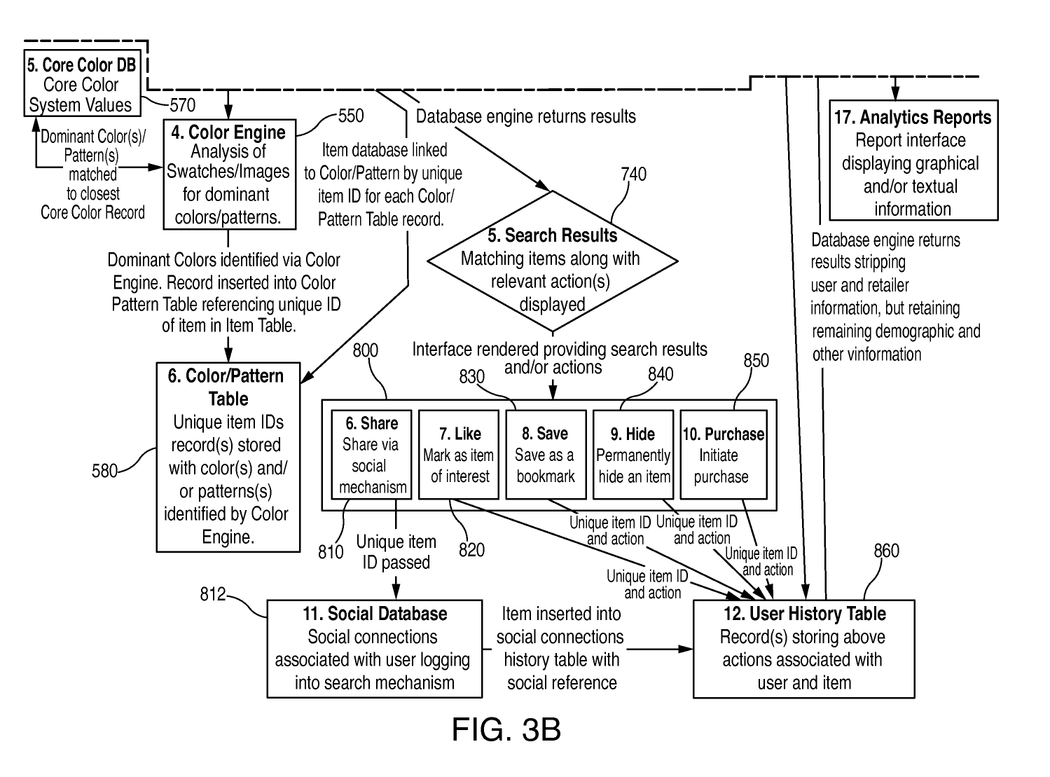

Personal information and demographic information are typically acquired from a user in the context of an initial user registration process and subsequently stored in a user history table 860 (see FIG. 3B) which contain a broad range of records pertaining to user identification and user selections. The remaining forms of user data 202 are acquired and recorded in the user history table 860 (see FIG. 3B) as a result of user-system interactions via a graphical user interface. In the mobile context, user-system interactions readily translate from the desktop embodiment to mobile. These interactions will be described below in further detail.

In a preferred embodiment of the present invention, merchant data 204 includes data specifics for a merchant, such as:

1. Business name, contact name, address, telephone number;

2. Demographic information, including but not limited to, target demographics, user and merchant demographics and preferences;

3. Physical locations;

4. Inventory information;

5. Supply chain information;

6. Planogram and store schematic information; and

7. Purchase history information;

In a preferred embodiment of the present invention, product data 206 includes data specifics for products, such as:

1. Basic product identification information, including name of product;

2. Color identification information, including universal hexadecimal color code and corresponding component red, green, blue (RGB) values, color histogram and statistical information;

3. Pattern identification information, where applicable;

4. Image data, preferably in the form of a three-dimensional digital rendition of the product or another form of digital image of the product;

5. Recommendation data, including historical recommendations of products, ratings of products and advertisement data pertaining to products; and

6. Current and future product availability information.

It should be appreciated that data stored as product data 206 can be indexed and cross-referenced in a number of useful ways by associating the product data 206 with specific types of user data 202, merchant data 204 and color data 208. Thus, various types of product data 206 can be referenced and manipulated utilizing, for example, any combination of color, land location, user preference and demographic. In that way, data in the data warehouse 200 is interrelated forming a powerful tool in the context of predictive analytics.

In a preferred embodiment of the present invention, color data 208 includes data specifics for color information, such as:

1. Color identification information in the form of hexadecimal codes for each selectable color;

2. Color identification information in the form of RGB component intensities for each selectable color, with RGB intensities mapped to the corresponding hexadecimal codes;

3. Pattern identification information in the form of pre-determined pattern configurations;

4. Statistical color information, such as frequency of products that contain a particular color among selectable colors, and trending information, such as which colors are forecasted as popular colors for selected past, present and future seasons;

5. Astrological information, including colors are associated with each astrological sign;

6. Keyword information, such as frequent user-associated keywords relating to a particular color. The associated keywords may be based on (a) an original color-word association index; (b) user-defined keywords whereby a user associates colors with specific keywords; (c) pre-determined keywords which the user links with colors that the user determines are associated with those pre-determined keywords. The keywords and their color associations are stored and updated as users continue to update and create associations; and

7. Color grouping information, such as colors associated with a timeless collection or a particular trending collection (e.g., Spring 2012 colors).

Color identification information and pattern identification information are preferably maintained as a core color database 560 with individual entries corresponding to each selectable color and selectable pattern against which, in specified instances, dominant colors and patterns may be determined and associated with products after being transmitted to server 100.

In a preferred embodiment, the system, methods and interfaces described herein are designed to operate in a 4096 color environment, but on a scale which allows the system to expand to over 16 million colors using the full range of 256 color intensities (measured from 0 to 255) for each of R (Red), G (Green) and B (Blue) which yields 256³ or 16,777,216 possible color variations, and hence potential color classifications. In a preferred embodiment, the 4096 selectable colors are equidistantly spaced along the full scale of available colors. However, it should be understood that the selectable colors may be moved along the scale or added or subtracted in order to provide more or less variation in a particular color region, depending on user and merchant trends or needs.

Typically, the RGB codes or component intensities for a particular color are expressed as a 24-bit, 6-digit hexadecimal code which uses a base sixteen number instead of conventional base ten numbers, two digits for each of the Red, Green and Blue values. Similarly, colors may be expressed as a concatenation of digital values for R, G and B components of a color and assigned to a product as a color identifier. To that end, if a particular color exhibits RGB values: 189 Red: 202 Green: 220 Blue, that number is converted to a hexadecimal value BDCADC which is also used. 189 corresponds to BD in hex notation, 202 corresponds to CA in hex notation and 220 corresponds to CD in hex notation.

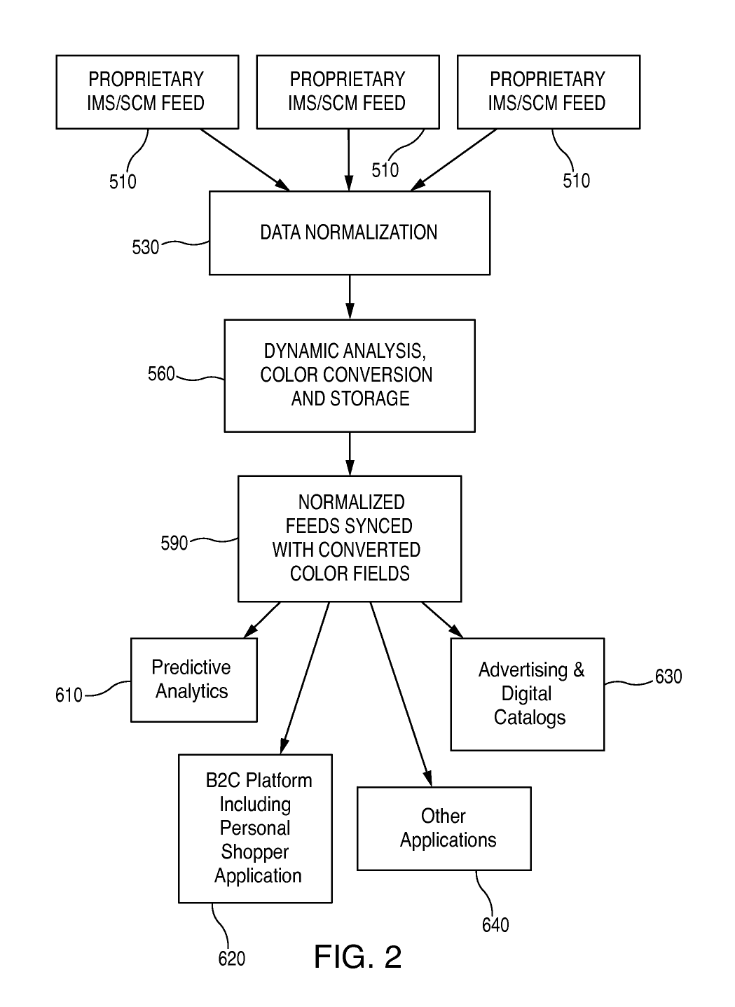

Referring again to FIG. 1, server 100 is also in communication with proprietary merchant IMS and SCM systems 500, which are typically closed systems that are inaccessible to the public or to third party merchants. As referenced in FIG. 2 and FIG. 3, proprietary merchant IMS and SCM systems 500 provide continuous or frequently updated (in excess of once per day) data feeds 510 to server 100, which include product data, inventory data and supply chain data. This function is performed in a closed environment, typically tailored to the requirements and requests of individual merchants.

From a merchant perspective, basic merchant information (e.g., name of company, mailing address, contact information) is requested and integrated to create a merchant account and ID. As described in more detail below, once a merchant account is created, merchants provide formatted product feeds for processing that include basic product identification, pricing information and unique color information.

Under traditional circumstances, before data on a new product entering a merchant's product line is fed to server 100, that data is initially input into a merchant's SCM system in accordance with its pre-production and supply chain management practices. The input of that information conforms to a pre-approved, customized or stock format that is suitable to the merchant's routine practices and which coincides with a format that is compatible with server 100 software implemented for subsequent processing of the data.

For example, where a new product comprises a piece of clothing, available fields for supply chain data input may include any number of relevant categories, including product type, material type, size(s) and number of units to manufacture. These data may be utilized to create a digital three-dimensional (3D) model of the piece of clothing, which, in addition to the foregoing data, can optionally be stored as product data 206. The number of fields may be expanded or contracted as desired so long as the format remains compatible with server 100 software so that the data in the field can be recognized and processed.

Significantly, fields that identify color utilizing an unmistakable, universal hexadecimal color code (or its corresponding RGB component measurements or other digital representation) are required in most instances and comprise the most preferred means to identify color(s) in which a product is produced and input into a merchant SCM to initiate production. Alternatively, fields that accept an anonymous color swatch—from which a universal 24-bit hexadecimal color code (or its corresponding RGB component measurements) can be identified by a color engine 550 via image/swatch analysis 560—may be utilized as a less preferred but acceptable means to identify color. A field for proprietary color names owned and used by merchants may also be utilized in conjunction with the foregoing color identification information, but not as a replacement.

Upon following an acceptable format and input of information, SCM data feeds 510 are transmitted and loaded onto server 100 by the merchant's SCM system 500 as soon as the product goes into production. As products are manufactured and are ready to enter inventory, the databases in a merchant's IMS and SCM systems 500 are updated to reflect available inventory of product, resulting in additional data being sent from the closed IMS and SCM systems 500 to server 100. In a preferred embodiment, once products enter merchant inventory, events are triggered to issue and release targeted advertisements, digital catalogues and other marketing tools to connect now-available products with consumer users. Where there are delays in production of product of a certain color, the IMS and SCM feeds 510 are likewise updated, which may trigger other advertising events. As available products are sold, IMS and SCM systems 500 continue to be updated, with corresponding data being sent to server 100. While the example herein references information initially input and fed to server 100 via the supply chain, it should be appreciated that information may be fed to server 100 utilizing inventory management information which typically relates to the post-production status of product.

Since information relating to products provided by different merchants is often expected to be formatted differently from one another, product and color data received from merchants must be transformed or normalized so that the information may be handled efficiently and consistently. While the information may be segmented by merchant, a merchant product table or item table 540 is created and maintained to manage, manipulate and search all of the types of information stored in product data storage 206. In practice, as formatted data from the IMS and SCM feeds 510 are introduced to the server 100, they are fed into a middleware engine 520 via an application programming interface. Generally, the middleware engine 520 is segment of software which enables the integration and management of incoming data as the data is transmitted from IMS and SCM systems 500 to server 100. In that regard, the middleware engine 520 manages the interaction between the otherwise incompatible applications residing on the server 100 and merchant IMS and SCM systems 500. While the input of the middleware engine 520 comprises the formatted IMS and SCM feeds 510, the output is normalized so that the data can be efficiently organized in an item table 530 in accordance with conventional normalization practices that are known in the computer software arts.

In a preferred embodiment, the normalization process 530 also strips away identification information which could be used to relate product information to a specific merchant. Accordingly, concern regarding access to sensitive information by competitors is effectively eliminated by removing access to the IDs of merchants from the products they sell.

After the normalization process 530 is completed by the middleware engine 520, item table 540 contains all available product information from the proprietary merchant IMS and SCM system 500, which includes a universal color identifier in the form of a hexadecimal color code, preferably along with component RGB values.

There are instances in which merchant IMS and SCM systems 500 and formatted feeds 510 will not contain the appropriate hexadecimal color identification required to classify a product by one of the available, selectable colors. These instances may arise as a result of previously adopted color naming conventions by a merchant or as a result of merchant-vendor practices which are ostensibly incompatible with assigning a universal color code to a given product via the merchant's IMS and SCM system. Under these circumstances, formatted feeds 510 are fitted with an available data field into which an anonymous, preferably digital, color swatch alone or in combination with a merchant color name (or names) for that swatch may be inputted by a merchant.

After the color swatch is formatted and incorporated into the feed 510, it is sent with the rest of the available merchant product data to server 100 where it is transformed or normalized 530 by the middleware engine 520 and then introduced to color engine 550 which performs an analysis of the color swatch 560 to determine its dominant color(s) (and pattern(s) where applicable). As referenced in FIG. 2 and FIG. 3, primary functions of the image processing module or color engine 550 are to gather and process the available color and pattern data in an image or color swatch presented via the proprietary merchant data feed 510 and to store the color and pattern data as product data 206 560. Thus, the color engine 550 serves as a “reader” of both colors and patterns on behalf of merchants, enabling the system to directly determine the colors and patterns of a product in a given image when that information is not provided via the formatted feed 510. Whether in the form of a color swatch or complicated image of a product, its color and patterns can be “read” by the color engine 550 and introduced to the data storage warehouse 200.

Following the consumption of normalized data from SCM and ISM feeds 510 and color assignment utilizing, for example, universal hexadecimal color identifiers, a number of merchant tools are enabled which pertain to predictive analytics 610, a B2C platform which includes a digital personal shopper application 620 (described herein), advertising to consumers 630 and other applications 640. Notably, these tools leverage the ability of the system to capture codified color data from a plurality of customized proprietary IMS and SCM systems 500 previously available in the prior art.

With reference to FIG. 3 and FIG. 4, all user subscribers gain entry and access to a graphical user interface by subscription and by using known security approaches, such as a login and password 710, which are optionally managed by a separate login server (not shown). Once a login 710 is confirmed and a subscriber authenticates, a user's age, gender, location and other demographic information is loaded 720 and the verified user is permitted access to the search query functions 730.

A color-based search query may be initiated via graphical user interface 750, such as one presented in FIG. 4 by activating the search icon 752. By selecting a selectable color area or swatch, such as one presented in the desktop version, and inputting textual parameters, a user may initiate a search for products from item table 540 (and color pattern table 580) with the associated digital color codes (e.g., in hexadecimal, RGB, binary) that correspond to the selectable color area.

Preferences in the color swatches appearing on the interface 750 may also be controlled and modified, typically utilizing the bookmark icon 754. In controlling changes to selectable colors that readily appear on the interface 750, a user may also be presented with a modify color panel (not shown).

A query may also be devised by a user via the grabber icon 756 which is particularly well-suited for a mobile setting. Utilizing this feature, a user may capture an image with the mobile device which can then be uploaded to the color engine 550 for processing. Using the available information taken from the image (e.g., color(s), patterns, type of product), a query is created using the information contained in the image. After a search is performed, matching products are returned as search results.

Ideally, matches that are made comprise products from the item table 540 with associated colors that are identical (e.g., same hexadecimal and RGB values) to the color that is selected on the color bar. However, it may also be desirable under certain circumstances to return products with matching colors which are not identical, but which have a color code identification that is nearly the same or the one closest to the queried color. As noted above, in determining the closest matching color to the queried color, the software executes the following calculation c=sqrt((r−r₁)²+(g−g₁)²+(b−b₁)²), wherein c=closest color; r=first red value; r₁=second red value; g=first green value; g₁=second green value; and b=first blue value b₁=second blue value. The candidate matching color is the one or more colors that yield the value closest to zero.

While the embodiments illustrated herein enable a user to search for a plurality of desired colors in one item (e.g., a first color and a secondary color), as well as specific pattern-color combinations (e.g., blue and red plaid), it should be appreciated that the system and storage may be configured to enable a user to search for “complementary” colored items to a queried color. To that end, in addition to the hexadecimal codes and RGB codes and other information associated with a particular color, a listing comprising one or more complimentary colors may be associated with each selectable color. Rules for determining what colors constitute a complimentary color may be incorporated such that queries return applicable results when the complementary color search is desired. For example, since a given shade of blue is known to complement or “go with” all other shades of blue along with a small sample of shades of red, the item table 540 and core color database 570 may list lists the complimentary shades of blue and red accordingly. Based on the rules, complimentary colors may be found in predetermined ranges, thereby allowing for multiple shades of a particular color to be categorized the same with respect to being identified as a complimentary color.

In addition to receiving results 740, a preferred embodiment of the system further provides a user with a number of user actions or options 800 to share the product via a social medium 810 (and to a social database 812), to “like” the product 820, to save the product as a bookmark 830 or into a user registry, to “hide” the product to ensure that it never appears again in a user's search results 840, and to purchase the product 850. When selections are made, they are stored as records in a user history table 860 of the system to analyze and utilize for future recommendations to the user and to others with correlating selections and/or demographics. Thus, information from searches performed by users of available products or merchant inventory is organized and indexed as user data and is used to formulate user preferences that is available to be used for future recommendations to the users providing the data, as well as to other users sharing common user demographics and/or online shopping activities.

When utilizing a mobile computing device, such as the one shown in FIG. 4, a number of additional features and capabilities become available to a user beyond those furnished via the desktop platform. The mobile embodiment of the present invention effectively functions as a personal shopper application which may be employed to guide or direct a user through a store or to identify the location of products within a store.

Building on the framework of the desktop embodiment shown in FIG. 3A and FIG. 3B, a location table is provided which contains merchant data records. These data records contain physical layout details of the retail locations in which products are sold. In particular, two different forms of data records are found in the location table: 1. store schematic records, and 2. planogram records. While the two are related, they serve different purposes. Store schematic records or schematics refer to the physical layout, blueprint or map of the store, including walls, aisles, stairs, pillars, fixed shelves and other constants pertaining to the physical features of a store that typically do not change from day-to-day unless the store undergoes structural renovations. Planogram records or plan-o-grams refer to a map showing the physical location of products offered for sale within a store, preferably in 3D. Typically, each store location has a single schematic which does not change and a corresponding planogram which changes on a regular basis. On a graphical user interface, a store's planogram is typically layered over the schematic to give users information as to where products are located in a store. Planograms are intended to change or transform as products at a particular store location are stocked, sold or moved from one location in the store to another. While layering of the planogram and the schematic is preferred, the two may be integrated with one another to create a single data record that contains both categories of information.

In the location table, schematic and planogram data are related to one another such that every planogram record is related to a schematic record and its store. In addition, each schematic record is related to its corresponding physical store location. With respect to other relationships maintained in data warehouse 200 and its databases, each store has a single real-time planogram that relates to a plurality of product records in item table 540 and/or color/pattern table 580. Conversely, each product referenced in item table 540 and/or color/pattern table 580 is related to or associated with a particular location listed in the location table. To determine item locations, coordinates on a planogram and/or schematic in X,Y,Z format can be related to items so that a particular item also has a corresponding X,Y,Z coordinate entry mapped to a particular planogram and/or schematic.

Planogram records are intended to change as a function of time and physical movement of product. In particular, as the inventory of a particular store changes, such as when a product is purchased and leaves the store, the planogram information changes once a sale is registered. For example, if the purchased product was the last one of its kind, the planogram reflects a zero count for the store of the particular product that was purchased. While sales can automatically trigger planogram changes, the arrival of new inventory or movement of products already in the planogram, typically necessitates some form of entry by an associate employed by the store to reflect a change in the planogram coordinates for the particular product. In each of these instances, changes in the planogram affect its appearance as an overlay in the graphical user interface.

Mobile access to a location schematic and an associated planogram is enabled via user login 710 and authentication. Once authentication is complete, a user may obtain a store schematic and its planogram by referring to a local map accessible by the mobile device and then selecting a store location with an available schematic and planogram. Once a store location is selected, its schematic and its current planogram are downloaded to the mobile device. Prior to download, a check is performed to determine whether a current schematic and planogram are already resident on the device. If the requisite content is not on the device or not current, current content is delivered automatically to and downloaded to the device.

Depending on entries recorded in user history table 860 prior to access, the downloaded planogram is able to point out on the interface products associated with user color preferences, specific products which the user has bookmarked and/or products which may otherwise correspond to entries in the history table 860. Attribute information pertaining to the products displayed in the planogram is provided via relationships with item table 540 and/or color/pattern table 580. Queries for updates to the planogram can be initiated by the mobile device. Alternatively, updates of the planogram can be delivered automatically if there are any changes to the planogram or if there are changes which specifically relate to the user's preferences and more particularly the user's user history table 860.

Upon authentication, mobile access to a store schematic and planogram may also be achieved by the mobile device becoming associated with a store as a function of the device's proximity to the store. For example, a user may choose to enable associations and schematic and planogram downloads when the device is within 15 feet of a store, which may be determined by the mobile device using its geolocator capabilities. Alternatively, a user may choose to enable these functions only when a user enters the store. Preferably, initiation of the mobile device association with the store and downloads would be premised on the availability of product in that store in which a user would be interested in purchasing.

Once in the store, using known geolocator techniques available based upon a combination of elements in the store and in the mobile computing device, such as triangulation, a device's precise location in the store can be identified and mapped to the store planogram and/or schematic. As a consequence of identifying the user's location, identifying the store layout by the store schematic, and identifying product placement by the planogram, the search and display capability is expanded to allow the user to be directed to a product of interest.

FIG. 5 shows a store map, using a portion of the delivered store schematic, and a pointer indicating the location of a selected product, using a portion of the delivered store planogram. While the interface is presented in 2D, it should be appreciated that the interface may be modified to present a 3D display of products in a selected section of a store (e.g., upper shelf, middle shelf, lower shelf) once a users is within viewing range of the product. By selecting a product from a list of products at the bottom of the interface, a user is shown where the product is located in the store. Likewise, toggling among different items listed in the interface will point to different locations corresponding to the planogram.

If a user is present in the store, the user's movement through the store can also be tracked so as to better direct the user to the product using conventional geolocation techniques. Furthermore, in some implementations, the user can be guided along a route through the store whereby that user passes other products which may be of interest and/or products which are in that user's preferred colors. Directions and guidance and a notification of when the user is near the product may be provided visually, audibly or both.

Particularly, where there are many items of user interest coinciding with the planogram, the interface may list each item so that a user can click on one item at a time to see where that item is located in the store. Alternatively, the interface can be configured to see the location of all items of interest simultaneously.

The accompanying description and drawings only illustrate several embodiments of a system, methods and interfaces for color-based identification, searching and matching, however, other forms and embodiments are possible. Accordingly, the description and drawings are not intended to be limiting in that regard. Thus, although the description above and accompanying drawings contain much specificity, the details provided should not be construed as limiting the scope of the embodiments but merely as providing illustrations of some of the presently preferred embodiments. The drawings and the description are not to be taken as restrictive on the scope of the embodiments and are understood as broad and general teachings in accordance with the present invention. While the present embodiments of the invention have been described using specific terms, such description is for present illustrative purposes only, and it is to be understood that modifications and variations to such embodiments may be practiced by those of ordinary skill in the art without departing from the spirit and scope of the invention.

1. A method of delivering the location of a product of interest to a user with a mobile computing device, comprising the steps of:
transmitting a first data set comprising a reference from a user history table to a product of interest bookmarked by said user;
determining the proximity of said mobile computing device with a store having said product of interest;
upon entry of said mobile computing device into said store, transmitting a second data set comprising a schematic diagram of said store and a planogram identifying a location of said product of interest in said store; and
displaying on a user interface the location of said product of interest in relation to said schematic diagram of said store.

2. The method of claim 1 further including the step of transmitting data representing the location of the mobile computing device in relation to said store.

3. The method of claim 1, further comprising the step of providing audible feedback to said user via said mobile computing device when said device is proximal to the product of interest.

4. The method of claim 1, further comprising the step of providing visual feedback to said user via said mobile computing device when said device is proximal to the product of interest.

5. The method of claim 1, further comprising the step of delivering location data of products that match a bookmarked color of said user.

6. The method of claim 1, wherein said planogram identifies the location of all products in said store.

7. The method of claim 1, further comprising the step of delivering planogram updates to said mobile computing device when there are changes to said planogram.

8. The method of claim 7, wherein said changes to said planogram relate exclusively to said user's product preferences.

9. The method of claim 8, wherein said planogram is overlayed on said store schematic.

10. A non-transitory computer readable storage medium, in communication with color data storage and product data storage, said product data storage being populated by merchant IMS/SCM feeds, and said non-transitory computer readable storage medium storing one or more programs, the one or more programs comprising instructions, which when executed by a computer, cause the computer to:
transmit a first data set comprising a reference from a user history table to a product of interest bookmarked by a user;
determine the proximity of said mobile computing device with a store having said product of interest;
transmit a second data set comprising a schematic diagram of said store and a planogram identifying a location of said product of interest in said store; and
display on a user interface the location of said product of interest in relation to said schematic diagram of said store.

11. The device of claim 10 further including the step of transmitting data representing the location of the mobile computing device in relation to said store.

12. The device of claim 10, further comprising the step of providing audible feedback to said user via said mobile computing device when said device is proximal to the product of interest.

13. The device of claim 10, further comprising the step of providing visual feedback to said user via said mobile computing device when said device is proximal to the product of interest.

14. The device of claim 10, further comprising the step of delivering location data of products that match a bookmarked color of said user.

15. The device of claim 10, wherein said planogram identifies the location of all products in said store.

16. The device of claim 10, further comprising the step of delivering planogram updates to said mobile computing device when there are changes to said planogram.

17. The device of claim 16, wherein said changes to said planogram relate exclusively to said user's product preferences.

18. The device of claim 17, wherein said planogram is overlayed on said store schematic.

19. With a processor in communication with a data warehouse and a mobile communication device, a method of delivering the location of a product of interest to a mobile computing device interface comprising the steps of:
responding to a query from a mobile computing device operated by a user for data representing said user's a product of interest in a preferred color
receiving confirmation from said mobile computing device that said device is in a store associated with available schematic and planogram data;
querying a second data base for map data of said store and directing said second data base to deliver said map data of said store, said map data including the location of said product of interest in said store.

20. The method of claim 19 further including the step of transmitting data representing the location of the mobile computing device in relation to said store.

21. The method of claim 19, further comprising the step of providing audible feedback to said user via said mobile computing device when said device is proximal to the product of interest.

22. The method of claim 19, further comprising the step of providing visual feedback to said user via said mobile computing device when said device is proximal to the product of interest.

23. The method of claim 19, further comprising the step of delivering location data of products that match a bookmarked color of said user.

24. The method of claim 19, wherein a planogram identifies the location of all products in said store.

25. The method of claim 24, further comprising the step of delivering planogram updates to said mobile computing device when there are changes to said planogram.

26. The method of claim 25, wherein said changes to said planogram relate exclusively to said user's product preferences.

27. The method of claim 26, wherein said planogram is overlayed on a store schematic.

28. A non-transitory computer readable storage medium, in communication with color data storage and product data storage, said product data storage being populated by merchant IMS/SCM feeds, and said non-transitory computer readable storage medium storing one or more programs, the one or more programs comprising instructions, which when executed by a computer, cause the computer to:
respond to a query from a mobile computing device operated by a user for data representing said user's a product of interest in a preferred color
receive confirmation from said mobile computing device that said device is in a store associated with available schematic and planogram data;
query a second data base for map data of said store and directing said second data base to deliver said map data of said store, said map data including the location of said product of interest in said store.

29. The device of claim 28 further including the step of transmitting data representing the location of the mobile computing device in relation to said store.

30. The device of claim 28, further comprising the step of providing audible feedback to said user via said mobile computing device when said device is proximal to the product of interest.

31. The device of claim 28, further comprising the step of providing visual feedback to said user via said mobile computing device when said device is proximal to the product of interest.

32. The device of claim 28, further comprising the step of delivering location data of products that match a bookmarked color of said user.

33. The device of claim 28, wherein a planogram identifies the location of all products in said store.

34. The device of claim 33, further comprising the step of delivering planogram updates to said mobile computing device when there are changes to said planogram.

35. The device of claim 34, wherein said changes to said planogram relate exclusively to said user's product preferences.

36. The device of claim 35 wherein said planogram is overlayed on a store schematic.

37. A method for a mobile computing device to display a product of interest to a user comprising the steps of:
receiving from a first data base a user profile of a user, said profile including user expressed products of interest and preferred colors,
delivering a query to a server for map data of a store, said query comprising geolocator data representing the present location of said device,
receiving in response to said query, map data indicative of the locations of products by color for products proximal to said present location of said device, said map data obtained a second data base, and
displaying at least a portion of a map formulated by said device using said map data, said display indicating the location of at least one product in a preferred color.

38. The method of claim 37, further including the step of transmitting data representing the location of the mobile computing device in relation to said store.

39. The method of claim 37, further comprising the step of providing audible feedback to said user via said mobile computing device when said device is proximal to the product of interest.

40. The method of claim 37, further comprising the step of providing visual feedback to said user via said mobile computing device when said device is proximal to the product of interest.

41. The method of claim 37, further comprising the step of delivering location data of products that match a bookmarked color of said user.

42. The method of claim 37, wherein a planogram identifies the location of all products in said store.

43. The method of claim 42, further comprising the step of delivering planogram updates to said mobile computing device when there are changes to said planogram.

44. The method of claim 43, wherein said changes to said planogram relate exclusively to said user's product preferences.

45. The method of claim 44, wherein said planogram is overlayed on a store schematic.

46. A non-transitory computer readable storage medium, in communication with color data storage and product data storage, said product data storage being populated by merchant IMS/SCM feeds, and said non-transitory computer readable storage medium storing one or more programs, the one or more programs comprising instructions, which when executed by a computer in a mobile computing device, cause the computer to:
receive from a first data base a user profile of a user, said profile including user expressed products of interest and preferred colors,
deliver a query to a server for map data of a store, said query comprising geolocator data representing the present location of said device,
receive in response to said query, map data indicative of the locations of products by color for products proximal to said present location of said device, said map data obtained a second data base, and
display at least a portion of a map formulated by said device using said map data, said display indicating the location of at least one product in a preferred color.

47. The computer of claim 46 further including the step of transmitting data representing the location of the mobile computing device in relation to said store.

48. The computer of claim 46, further comprising the step of providing audible feedback to said user via said mobile computing device when said device is proximal to the product of interest.

49. The computer of claim 46, further comprising the step of providing visual feedback to said user via said mobile computing device when said device is proximal to the product of interest.

50. The computer of claim 46, further comprising the step of delivering location data of products that match a bookmarked color of said user.

51. The computer of claim 46, wherein a planogram identifies the location of all products in said store.

52. The computer of claim 51, further comprising the step of delivering planogram updates to said mobile computing device when there are changes to said planogram.

53. The computer of claim 52, wherein said changes to said planogram relate exclusively to said user's product preferences.

54. The computer of claim 53 wherein said planogram is overlayed on a store schematic.

55. A system for providing product location data to a user comprising
a server;
a first data base for storing user data,
a second data base for storing store data, and
a mobile computing device;
where said mobile computing device communicates through said server with said data bases, delivers location data to said server indicating the geolocation of the device, receives indications of a user's product of interest from said first data base and map data from said second data base, and displays a map indicating the location of said product of interest.

56. The system of claim 55 further including the step of transmitting data representing the location of the mobile computing device in relation to said store.

57. The system of claim 55, further comprising the step of providing audible feedback to said user via said mobile computing device when said device is proximal to the product of interest.

58. The system of claim 55, further comprising the step of providing visual feedback to said user via said mobile computing device when said device is proximal to the product of interest.

59. The system of claim 55, further comprising the step of delivering location data of products that match a bookmarked color of said user.

60. The system of claim 55, wherein a planogram identifies the location of all products in said store.

61. The system of claim 60, further comprising the step of delivering planogram updates to said mobile computing device when there are changes to said planogram.

62. The system of claim 61, wherein said changes to said planogram relate exclusively to said user's product preferences.

63. The system of claim 62 wherein said planogram is overlayed on a store schematic.
